(19) United States
(12) Patent Application Publication
(10) Pub. No.: US 2005/0274935 A1
(43) Pub. Date: Dec. 15, 2005

(54) Post puller

(76) Inventor: Mark Stephen Nelson, Dallas, TX (US)

Correspondence Address: Mark Nelson, 8714 San Leandro, Dallas, TX, 75218, US

(21) Appl. No.: 10/866,547

(22) Filed: Jun. 14, 2004

(51) Int. Cl. B66F 3/00

(52) U.S. Cl. 254/226

(57) ABSTRACT

A simple, stable, inexpensive, light weight, compact device that allows a single operator to vertically extract embedded objects such as fence posts. The device is placed over the object and a self tightening noose in the cable end is positioned around the object near the ground. A cable winch is then activated allowing for easy removal of the embedded object. After completion of the operation, the winch tension is released, the cable removed from the object, and the operator is free to begin the next operation.

### CROSS-REFERENCE TO RELATED APPLICATIONS

Not applicable

### STATEMENT REGARDING FEDERALLY SPONSORED RESEARCH OR DEVELOPMENT

This invention was not conceived or produced with the aid of any federally sponsored research or development.

### BACKGROUND OF THE INVENTION

1. Field of the Invention

This invention relates to an extraction device, specifically a tripod based, compact, light weight, cable winch powered device for removing objects embedded in the ground.

2. Description of Prior Art

Currently patented devices used for extracting posts have included such things as a simple lever type apparatus, complicated machines that must be attached to heavy equipment, and hydraulically powered systems. The disadvantage of the lever systems is that the lever fulcrum is laterally distant from the center of the piece to be extracted, which is an unstable system. The machines attached to such things as tractors and front loaders require the presence of this very expensive piece of equipment. Most hydraulic systems are also supported laterally distant from the extraction center and are generally heavy, complicated, and expensive.

A post puller in U.S. Pat. No. 6,389,188 to Salman, 2002 Jun. 4, has a center of extraction directly over the post however it is hydraulic, complicated, heavy, and lacks compactness.

A tree and stump removal apparatus in U.S. Pat. No. 4,893,783 to Diener et al, 1990 Jan. 16, has a tripod base but the center of extraction is significantly lateral to the piece to be extracted and is hydraulically operated.

A post puller in U.S. Pat. No. 6,382,594 B1 to Ransom, 2002 May 7, is an extremely complicated hydraulic machine that lacks compactness, light weight, and low cost of construction.

### BRIEF SUMMARY OF THE INVENTION

In accordance with the present invention, a post puller vertically extracts embedded objects from the ground utilizing a tripod based support structure to which is attached a cable winch. The support structure is placed over and around the embedded object and the winch cable is attached to the lower portion of the embedded object. An operator then simply activates the cable winch in order to extract the embedded object.

### OBJECTS AND ADVANTAGES

Accordingly, besides the objects and advantages of a post puller described in my above patent, several objects and advantages of the present invention are:
1. It is a simple mechanical device with low cost of construction.
2. A tripod base ensures stability.
3. The lift center of the device is very near the ground level center of extraction also promoting stability.
4. Swiveling legs allow for compact storage and transport.
5. Few moving parts ensure durability.
6. A cable cinch block allows for rapid, tight gripping to any size diameter of post as well as easy release.

### BRIEF DESCRIPTION OF THE SEVERAL VIEWS OF THE DRAWING

FIG. 1 shows a superior side view.

FIG. 2 shows a body.

FIG. 3 shows a bracket.

FIG. 4 shows a bracket pin.

FIG. 5 shows a leg.

FIG. 6 shows a pad.

FIG. 7 shows a roller.

FIG. 8 shows a roller pin.

FIG. 9 shows a cable.

FIG. 10 shows a cable cinch block.

FIG. 11 shows a cable and cable cinch block arrangement.

### REFERENCE NUMERALS IN DRAWING

1. Cable winch
2. Body
3. Bracket
4. Bracket pin
5. Leg
6. Pad
7. Roller
8. Roller pin
9. Cable
10. Cable cinch block
11. Bracket hole
12. Leg hole
13. Cinch block serrations

### DETAILED DESCRIPTION OF THE INVENTION

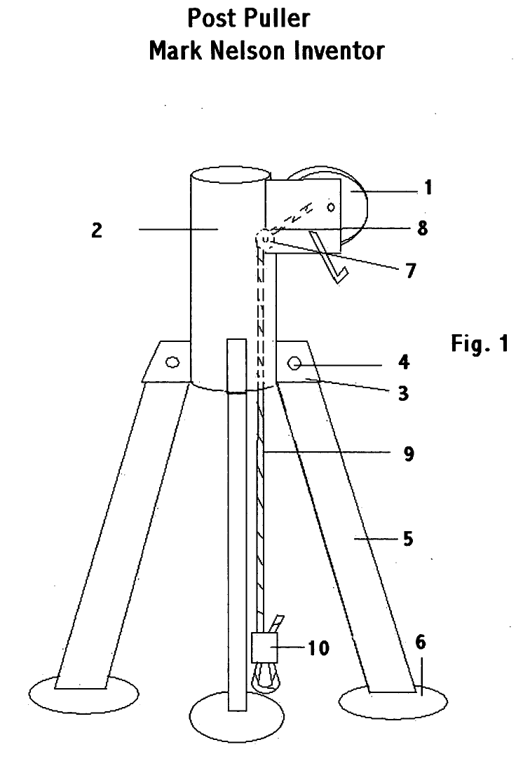

FIG. 1—Preferred Embodiment.

A preferred embodiment of the present invention is illustrated in FIG. 1.

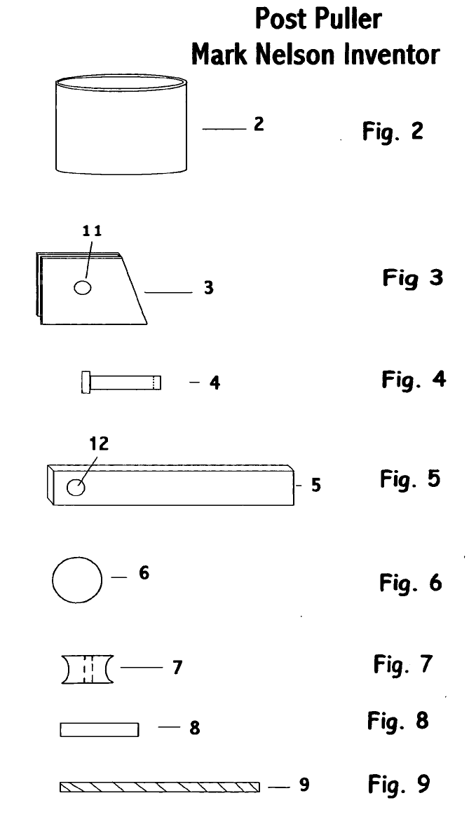

A body 2 as shown in FIGS. 1 and 2 may be produced from a group of materials consisting of steel (preferred), aluminum, titanium, or other material of suitable tensile and yield strength to accommodate the stresses of the a particular object to be extracted.

Onto the body 2 are attached 3 brackets 3 as seen in FIGS. 1 and 3 which can be produced from plate steel, aluminum, or other durable material and serve as support for a leg 5. A bracket hole 11 as seen in FIG. 3 is drilled in the top of the bracket and serves to facilitate attachment of the leg 5 to the bracket 3.

The leg 5 as seen in FIGS. 1 and 5 may be produced from tubular steel, pipe or any other material with adequate yield strength to support the object to be extracted. Into one end of the leg 5 is drilled a leg hole 12 as seen in FIG. 5 which allows the leg 5 to swivel inward for storage or outward for operation. Through the bracket hole 11 and the leg hole 12 is inserted a bracket pin 4 as seen in FIGS. 1 and 4 which serves as a swivel attachment for the legs 5.

A pad 6 as seen in FIGS. 1 and 6 may be made from steel, aluminum, or any durable material that can be securely attached to the leg 5 and serves to prevent the leg 5 from boring into the earth.

A cable winch 1 as seen in FIG. 1 serves as the lift power for the device and is secured to the body 2 by welding, bolts, or other secure means of attachment.

A roller 7 as seen in FIGS. 1 and 7 is attached to the body 1 with a roller pin 8 and serves to allow a cable 9 passed over it to change direction with reduced friction.

The cable 9 as seen in FIGS. 1 and 9 may be produced from steel (preferred), strap, or any material with adequate tensile strength to lift the object of extraction.

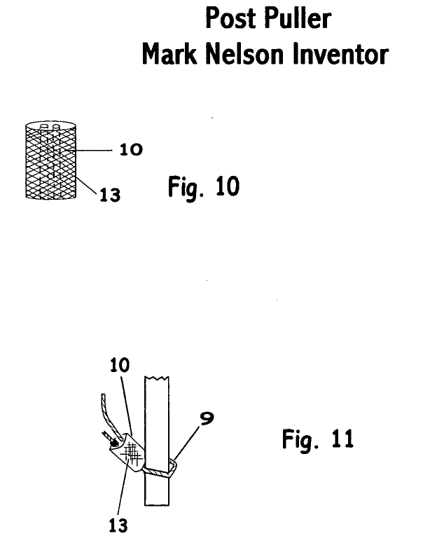

Onto one end of the cable 9 is attached a cable cinch block 10 as seen in FIGS. 1, 10, and 11. This may be produced from steel, aluminum, or any other durable material. Serrations 13 as seen in FIGS. 10 and 11 are cut into the cable cinch block 10 to allow gripping to the object of extraction. The cable 9 is run through the cable cinch block 10, around the object of extraction, and back though the cable cinch block 10 where it is attached. By this arrangement, the tighter the cable 9 is pulled, the stronger the cable cinch block 10 grips the object of extraction.

Advantages

(a) The device allows for a near vertical orientation of the center of lift for the device with the center of the object to be extracted. This prevents the support body from going sideways during operation.

(b) The device is very simple to operate. It is placed over the object of extraction, the cable is attached, and the cable winch is activated.

(c) With inexpensive materials and few parts the device is very cost effective to produce and relatively light in weight when compared to many other post pulling devices.

(d) The tripod supported base allows for a very stable lift platform.

(e) Folding legs allow for compact storage and transport.

Operation of the Invention

Operation begins by placing the body 2 over the object of extraction with the pads 6 resting on the ground. A loop in the cable 9 distal to the cable cinch block 10 is placed around the object of extraction near the ground. The cable winch 1 is then activated and the object is extracted from the ground.

The cable winch 1 is then loosened, the cable 9 is brought over the end of the extracted object and the device is then ready for the next extraction.

### CONCLUSIONS, RAMIFICATIONS, AND SCOPE OF THE INVENTION

Thus the reader will see that this invention creates a simple, economical, compact, and portable extraction device.

While the above description contains many specifications, these should not be construed as limitations on the scope of the invention. But rather as exemplification of one preferred embodiment thereof. Many other variations are possible. For example the height and size of the unit and parts can be increased to allow for greater lifting heights and size of the objects to be extracted. The number of legs may be varied. The strength of the winch can be varied to allow for greater or lesser lifting capacity. Many winch mechanisms such as hand or electric may be used. Materials may be changed to allow either greater or lesser durability or weight. Different shapes are possible without compromising functionality. Any color is possible. Numerous means for manufacture of the various parts are possible. Accordingly the scope of the invention should be determined not by the embodiment illustrated, but by the appended claims and their legal equivalents.

1. A device for extracting objects embedded in the ground comprising:
a body;
brackets attached to the body;
legs attached at one end to the brackets by way of pins passed though the brackets and legs allowing for swivel motion;
pads attached to the opposite end of the legs;
a cable winch attached to the body which serves as a power source for an extraction;
a roller attached to the body by way of a roller pin passed through the roller and secured to the body;
a cable running from the cable winch, over the roller, through the body, and around the base of the object of extraction; and
a cable cinch block though which the cable is passed creating a slip noose type configuration for gripping the object of extraction.
